(19) United States
(12) Patent Application Publication
(10) Pub. No.: US 2013/0043254 A1
(43) Pub. Date: Feb. 21, 2013

(54) SILICONE COOKWARE WITH REMOVABLE COVER AND CARRIER VESSEL

(71) Applicant: Julie Haworth, Plano, TX (US)

(72) Inventor: Julie Haworth, Plano, TX (US)

(21) Appl. No.: 13/211,688

(22) Filed: Aug. 17, 2011

(51) Int. Cl. A47J 27/00

(52) U.S. Cl. 220/573.2

(57) ABSTRACT

A cookware comprising a basin made from food-grade silicone, a removable cover made from food-grade silicone, and a removable carrier vessel made from a thermal insulator. The cookware can be subjected to a wide range of temperatures, and may be used in various environments, including conventional or radiation oven, refrigerator, or freezer. The removable carrier vessel adds structural stability to the silicone basin, and facilitates even heat distribution to the food material. The removable silicone cover has multiple functions, including serving as a splatter guard, protecting the food material from scorching or drying out, and distributing heat evenly along the top surface of the food material.

### BACKGROUND OF THE INVENTION

1. Technical Field

The present invention relates generally to flexible, nonstick cookware made from food-grade silicone.

2. Description of Related Art

There are several advantages of silicone cookware over conventional cookware made from metal, glass, or ceramic. Food-grade silicone approved by the U.S. Food and Drug Administration (FDA) is nontoxic and BPA-free. Silicone has low chemical reactivity, which prevents odors being transferred to and from food contained in cookware. Cookware made of silicone permits easy food release for two reasons. First, silicone cookware is inherently nonstick, thus little to no pre-lubrication (e.g., oil or flour) is necessary. The nonstick property also makes it easy to clean silicone cookware. Second, because silicone cookware is flexible, the basin containing food can be twisted or turned inside out.

Silicone cookware is thermally stable in a wide range of temperatures (generally −100 to 260° C. or −148 to 500° F.). It is safe to use in dishwasher, conventional oven, microwave oven, refrigerator, and freezer. Silicone cookware insulates heat better than metal cookware, so it promotes even heat distribution during the cooking process. This leads to evenly cooked food, which is especially important for baked goods. Another benefit of silicone cookware's thermal properties is that is cool to touch shortly after being removed from the heat source, unlike metal or ceramic cookware that requires longer cooling times.

Because of its numerous advantages over conventional cookware made of metal, glass, or ceramic, silicone cookware has quickly become a favorite in both commercial and household kitchens. But silicone cookware is not without its disadvantages. Silicone cookware's flexibility is a double-edged sword: while beneficial for easy food release, handling and structural stability issues are chief complaints among its users. When filled with a liquid or a semi-fluid (e.g., cake batter), gripping onto the sides of silicone cookware basin will collapse the sides inward and cause the user to spill its content. Users often resort to placing the silicone cookware on a metal cooking sheet when transporting. Aside from the inconvenience, using a metal cooking sheet as support can cause problems when silicone cookware is used for baking. In such a situation, the bottom of silicone cookware in direct contact with the metal sheet is subjected to conductive heating while the sides and the top of the cookware is subjected to convective heating. This causes the food product to be cooked unevenly.

Furthermore, most silicone cookware have one or more cavities (e.g., cup or basin) with one side completely exposed to heating elements. In baking context, for example, the bottom and sides of the baked good are protected and insulated by silicone cookware while the top is exposed to direct heat. Thus, the top of the baked good can dry up or even become scorched.

Therefore, a need exists for a silicone cookware that does not suffer from handling problems. A need also exists for a silicone cookware that promotes uniform heat distribution to food material contained therein and prevent unevenly cooked product.

### BRIEF SUMMARY OF THE INVENTION

The current invention proposes a remedy for the drawbacks and disadvantages of silicone cookware mentioned above. In one embodiment, the cookware comprises a basin with a cavity with at least one opening made from BPA-free, FDA-approved, food-grade silicone; a removable cover that is also made of the same silicone material; and a carrier vessel made of thermally insulating material.

The basin can be any number of shapes having an open top. In one embodiment, the basin has a planar bottom that is parallel to the opening. In one embodiment, the basin bottom can be made thicker than the side walls for a more even distribution of heat to the food material being cooked.

The removable cover can also vary in geometry as long as it can enclose the opening of the basin. The removable cover can be planar or can have a cavity so that the inner surface of the removable cover does not touch the food that is in the basin cavity. In one embodiment, the removable cover has one or more apertures.

The basin is removably installed in a carrier vessel shaped to accommodate and receive the basin. The receiving cavity of the carrier vessel is slightly larger than the outer contours of the basin to form a gap. In one embodiment, the carrier vessel is made from ceramic material. In one embodiment, the silicone basin has one or more tabs that protrude away from the removable carrier vessel.

### BRIEF DESCRIPTION OF THE DRAWINGS

A more complete understanding of the present invention may be had by reference to the following detailed description when taken in conjunction with accompanying drawings, wherein:

FIG. 1 shows a perspective view of a prior art silicone cookware;

FIG. 2 shows a perspective view of a prior art silicone cookware with a cover;

FIG. 3 shows an exploded view of one embodiment of the Applicant's silicone cookware basin and removable cover;

FIG. 4 shows a perspective view of one embodiment of the Applicant's silicone cookware basin and removable carrier vessel;

FIG. 5 shows an exploded view of one embodiment of the Applicant's silicone cookware basin and removable carrier vessel wherein the silicone basin has tabs; and

FIG. 6 shows a cross-sectional view of one embodiment of the Applicant's silicone cookware assembled, having a silicone basin, a removable cover, and a removable carrier vessel.

Where used in various figures of drawings, the same numerals designate the same or similar parts. Furthermore, when the terms “top,” “height,” “outer,” “inner,” “width,” “length,” “thickness,” “side,” “horizontal,” “vertical,” and similar terms are used herein, it should be understood that these terms have reference only to the structure shown in the drawing and are utilized only to facilitate describing the invention.

All figures are drawn for ease of explanation of the basic teachings of the present invention only; the extensions of the figures with respect to number, position, relationship, and dimensions of the parts to form the preferred embodiment will be explained or will be within the sill of the art after the following teachings of the present invention have been read and understood. Further, the exact dimensions and dimensional proportions to conform to specific width, length, and similar requirements will likewise be within the skill of the art after the following teachings of the present invention have been read and understood.

### DETAILED DESCRIPTION

Several embodiments of Applicant's invention will be described with references to the drawings. Unless otherwise noted, like elements will be identified by identical numbers throughout all figures. The invention illustratively disclosed herein suitably may be practiced in the absence of any element which is not specifically disclosed herein.

Though silicone cookware has garnered increasing market share in the recent years in both commercial and household kitchens, several disadvantages still exist. One of the primary issues with silicone cookware is handling problems. For example, a prior art silicone cookware, as illustrated by FIG. 1, has thin vessel walls made of silicone. This prior art is commercially marketed as Poachpod® 100 by Fusionbrands®. (U.S. Pat. No. 7,754,261.) Users of the Poachpod® 100 have to grab the side walls of the silicone cookware to transport it because there is not a particularly good location to grab. Holding onto just one or two of the protruding tabs 102 would disrupt the balance and cause the user to spill the content of the vessel when it is filled with fluid. Holding onto all three protruding tabs 102 would be difficult and inconvenient method of transporting the Poachpod® 100. Gripping the side walls of the Poachpod® 100 may also cause the user to spill if too much pressure is used. Furthermore, the rounded bottom 104 poses balancing problems and may cause the Poachpod® 100 to fall over when the vessel is set on an oven rack or a microwave oven carousel plate. Additionally, the smooth contours of the Poachpod® 100 poses a problem of slipping out a user's hand, especially if the user's hand is wet or greasy from touching the food material.

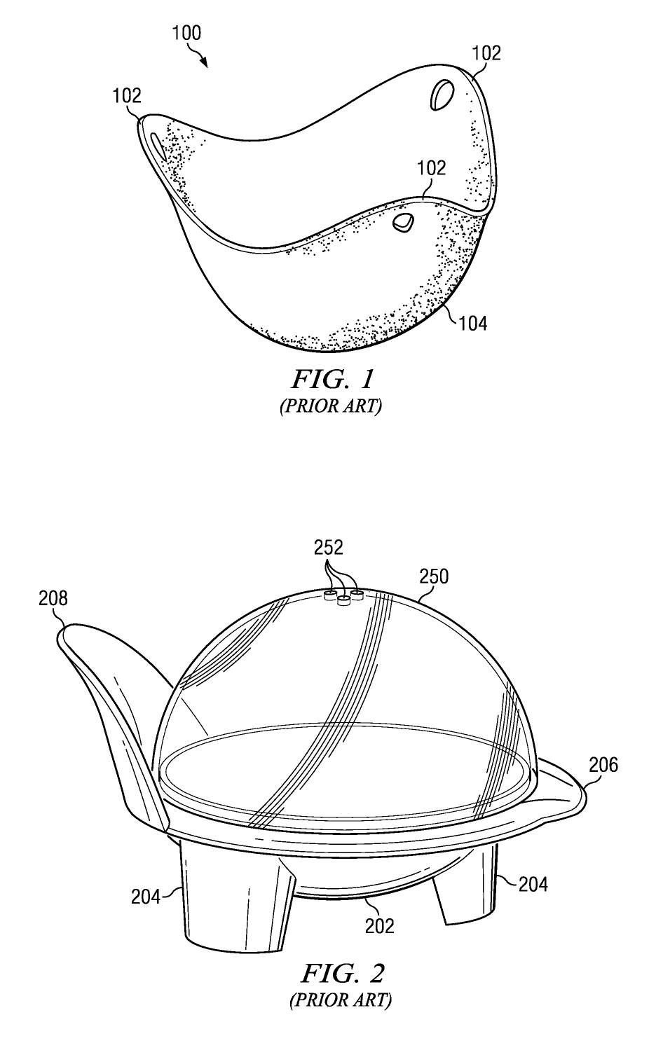

Another example of prior art silicone cookware is illustrated in FIG. 2. This prior art is marketed as “Silicone Single Egg Poacher” by Trudeau Corporation (“Trudeau Egg Poacher 200”). The Trudeau Egg Poacher 200 comprises a dish 202 made of silicone and a cover 250 made of polypropylene. Trudeau Egg Poacher 200 is designed to be used primarily in a microwave oven. The cover 250 is shaped like a dome, and has a plurality of perforations 252 at the top of the dome. The dish 202 is in a shape of an upside-down spherical cap. The dish 202 has a lateral tab 206 and a vertical tab 208 along the perimeter of the dish 202. The lateral tab 206 is located opposite the vertical tab 208. The dish 202 also has a plurality of feet 204 located on the bottom side of the dish 202.

While Trudeau Egg Poacher 200 attempts to address the handling issue of silicone cookware with the lateral tab 206 and a vertical tab 208, it is still not without problems. The user would need both hands to carry the Trudeau Egg Poacher 200 by grabbing onto the lateral tab 206 and the vertical tab 208 simultaneously. Carrying the dish 202 by just one tab would be difficult because the tab may bend with the weight of the filled dish, and the dish 202 would be out of balance and cause the user to spill its content. Having to use both hands to transport the Trudeau Egg Poacher 200 is inconvenient, especially if the user is rushing in a busy kitchen. Moreover, it is ergonomically awkward for a user to simultaneously grab the vertical tab 208 (pointed upward and located higher) and the lateral tab 206 (pointed sideways and located lower) while gauging whether the dish is level and maintaining balance.

Still more problems are posed by the cover 250 of the Trudeau Egg Poacher 200. Polypropylene is a poor choice of material if the cookware is to be used in conductive and convective heating environment; the melting point of polypropylene is 130-171° C. (266-340° F.). Furthermore, the shape and texture of the cover 250 offer another problem. The dome shape combined with the glossy texture of polypropylene makes the cover 250 difficult to handle. A cook with a wet or greasy hand would have a hard time grasping the cover 250.

Another problem with the Trudeau Egg Poacher 200 is its feet 204 along the bottom of the dish 202. The Trudeau Egg Poacher 200 is designed with only one purpose in mind—an egg poacher to be used in a microwave oven. The feet 204 would provide a workable solution to the balancing problem if it were to be used only in a microwave oven, but those feet 204 would fall through the oven racks or wire shelves in a refrigerator.

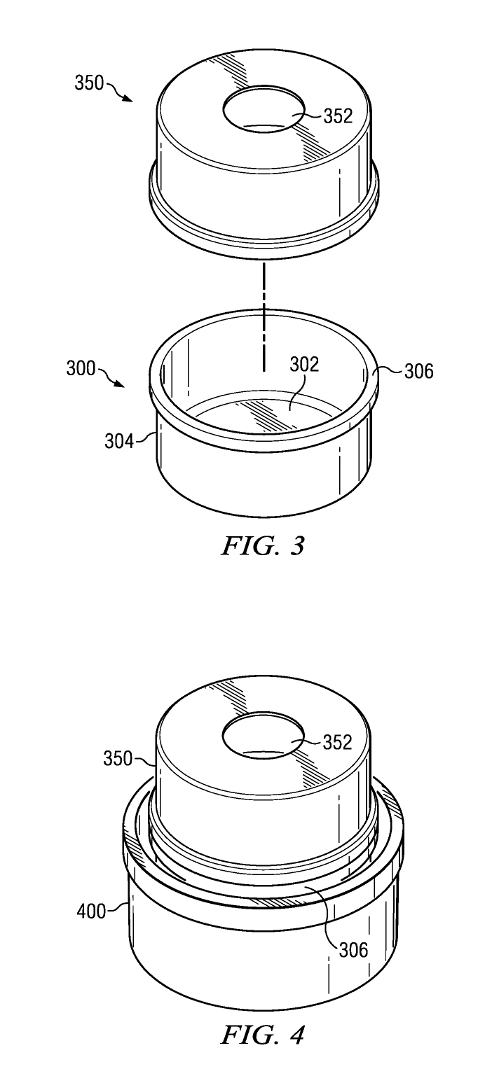

Applicant's cookware addresses abovementioned disadvantages and improves significantly upon prior art silicone cookware. Regarding now to FIGS. 3 and 4, in one embodiment, Applicant's cookware comprises a basin 300 made from food-grade silicone; an optional removable cover 350 that is also made food-grade silicone material; and an optional removable carrier vessel 400 made from a thermally insulating material. As used herein, food-grade silicone means any type of silicone approved by the U.S. Food and Drug Administration (FDA) that is nontoxic and BPA-free. Further, as used herein, thermally insulating material means any material with lower thermal conductivity than metallic material from which conventional cookware is made. As used herein, removable carrier vessel means a vessel made from thermally insulating material that is removably coupled with the basin 300, which enhances the handling and transport characteristics of the basin 300. All components of one embodiment of Applicant's silicone cookware—the basin 300, the removable cover 350, and the removable carrier vessel 400—are made of materials that is able to withstand a wide range of temperatures.

Applicant's silicone cookware basin 300 can be any three-dimensional shape as long as it has a cavity with at least one opening. In one embodiment, the basin 300 has a planar bottom 302 that is parallel to the opening. In another embodiment, the basin 300 shapes can include cylinders, truncated cones, cuboids, prisms of three or more sides, or any number of irregular shapes (e.g., egg-, heart-, or star-shaped, or fashioned after the letters of the alphabet).

In one embodiment, the planar bottom 302 affords at least two advantages over the Poachpod® 100. First, the planar bottom 302 resolves the balancing problems and stabilizes the silicone cookware basin 300 even when it is set on a moving or uneven surface. Second, the planar bottom 302 adds to the structural integrity of the silicone cookware basin 300. While the Poachpod® 100 with its smooth and streamlined contours may be aesthetically pleasing, its silicone walls are prone to change in shape and cave inward when the user grabs onto the outer surface of the Poachpod® 100. By contrast, in one embodiment of Applicant's silicone cookware basin 300, the planar bottom 302 acts as a lateral support for the side wall 304 of the basin 300, and prevents the side wall 304 from caving inward when the user grabs onto the side wall 304. Thus, users of Applicant's silicone basin 300 can transport it with just one hand. A user can rest the planar bottom 302 of the basin 300 on the palm of the hand or grab along the rim 306 or the side wall 304 of the basin 300 without worrying about the failure of structural integrity of the basin 300.

Additionally, in one embodiment, Applicant's silicone basin 300 has a rim 306 along the periphery of the cavity of the basin. The rim 306 has a thickness that is greater than the thickness of the side wall 304 of the basin 300, which prevents the basin 300 from easily slipping out a user's hand. The rim 306 further acts as another lateral support for the side wall 304 of the basin 300—in addition to the planar bottom 302—and prevents the side wall 304 from caving inward.

Applicant's cookware can be used with or without the removable cover 350. The optional removable cover 350 can vary in geometry as long as it can enclose the opening of the basin 300. The removable cover 350, is made of food-grade silicone, which has a naturally nonslip texture. In one embodiment, the removable cover 350 is planar (e.g., a circle of same or greater diameter as a cylindrical basin 300). In another embodiment, the removable cover 350 has a cavity (e.g., a dome of same or greater diameter as a cylindrical basin 300) so that the inner surface of the removable cover does not touch the food that is inside the basin 300 cavity. The removable silicone cover 350 insulates and distributes heat evenly across the top surface of the food being cooked and prevents it, from being scorched.

In one embodiment. As illustrated in FIG. 3, the removable cover 350 has one or more apertures 352. As used herein, aperture means one or more holes, perforations, or slits, which allow for ventilation of steam built up during the cooking process. The aperture 352 releases some steam without drying out the food, which results in a moist finished product. The removable cover 350 not only prevents the food from drying out but also acts as a splatter guard. This is especially advantageous when Applicant's silicone cookware is used in a microwave oven, where the rapid heating often causes food to splatter; the nonstick, removable cover 350 is much easier to clean than the whole microwave oven.

Applicant's silicone cookware is intended for varied use in not just a microwave oven but also in a conventional oven, a refrigerator, or freezer. Furthermore, while heat distribution is not of great concern in a microwave oven, it is a significant design consideration for a cookware that is to be subjected to both conductive and convective heating. A footed design, like that of the Trudeau Egg Poacher 200, would promote uneven heat distribution because the silicone feet 204 would absorb more heat than the dish 202 surface.

Because heat distribution is an important consideration for Applicant's cookware, other features of the cookware are also designed to contribute to even heat distribution. For example, in one embodiment, Applicant's silicone basin bottom 302 can be made thicker than the side walls 304. Most conventional ovens have heating elements located below the rack on which the cookware rests (at least when using the baking setting of the oven). Therefore, having a thicker bottom 302 promotes a more uniform temperature gradient along the inner surface of the basin 300, and prevents the food from being burned at the bottom. This will also help the cooked food to release easily off the basin 300 surface. Also, in one embodiment, the edges of the inner surface of the basin 300 are smoothly rounded to further aid easy release of the cooked food.

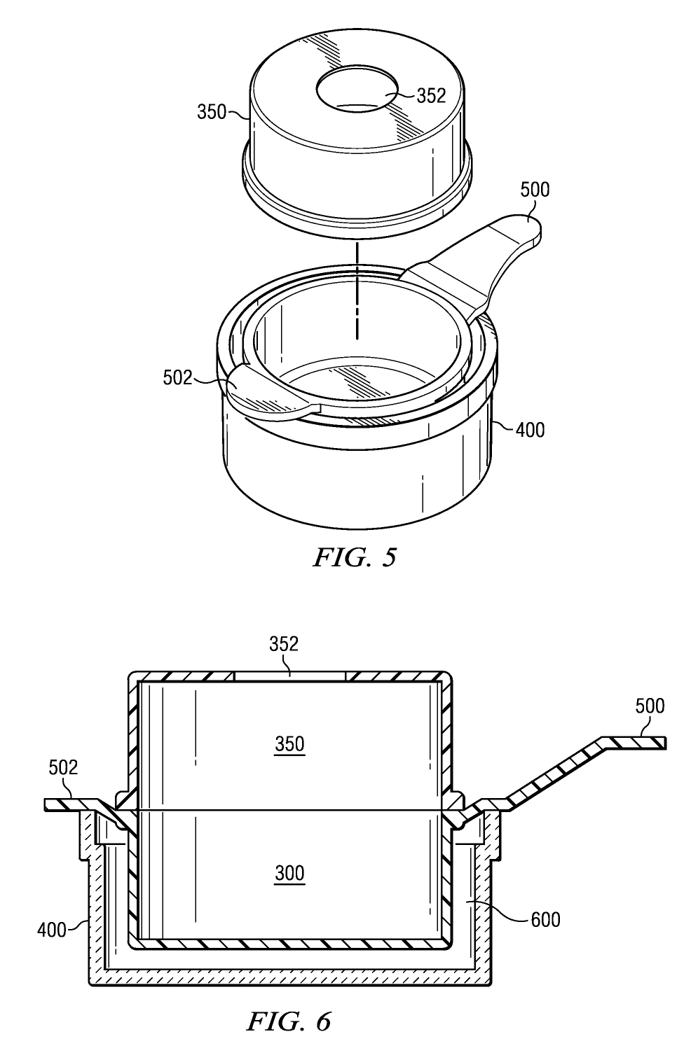

As illustrated in FIGS. 4 through 6, the basin 300 is encompassed by a removable carrier vessel 400. For example, FIG. 5 shows one embodiment of Applicant's cookware, comprising a basin 300 made from food-grade silicone; an optional removable cover 350 that is also made from food-grade silicone; and a removable carrier vessel 400 made from a thermally insulating material. As can be seen in FIG. 5, the basin 300 is encompassed within the removable carrier vessel 400, and the cover 350 is shown above the basin 300.

In one embodiment, the removable carrier vessel 400 is made of a thermally insulating material that is moldable during the fabrication of the vessel but rigid when made into the final carrier vessel 400 product. This is so that the removable carrier vessel 400 can be shaped to accommodate and receive basins 300 of varying geometry. The receiving cavity of the carrier vessel 400 is slightly larger than the outer contours of the basin 300 to form a spatial gap 600 (FIG. 6). In one embodiment, the spatial gap is maintained by the rim 306 of the basin 300, which rests on the periphery of the removable carrier vessel 400 (see FIG. 4).

In one embodiment, the removable carrier vessel 400 is made of ceramic material, which is an excellent thermal insulator. Such a carrier is also known as a ramekin. Using the ceramic carrier vessel 400 is far superior compared to resting a flexible silicone cookware on a metal cooking sheet, which conducts heat directly to the bottom of the silicone cookware. Furthermore, the heat distribution is enhanced by the spatial gap 600 (FIG. 6) between the silicone basin 300 and the ceramic carrier vessel 400. The gap 600 filled with air ensures that all sides of the basin 300 is subjected to convective heating rather than conductive heating. This results in more evenly cooked food products.

Besides its heat distributive effects, the removable carrier vessel 400 provide many advantages over conventional, flexible silicone cookware that must be carried on a metal cooking sheet. First, being made of ceramic, the removable carrier vessel 400 is safe to use in a microwave oven. Also, unlike metal cooking sheet or pan used as a makeshift support, the removable carrier vessel 400 is tailor-designed to be nearly as compact as the silicone basin 300. This is convenient when storing or cooling the food product in a refrigerator, where space is limited. Moreover, the removable carrier vessel 400 can double as a serving dish, which would not be feasible when using a metal cooking sheet or pan. Using the removable carrier vessel 400 as the serving dish obviates the need to transfer the cooked food out of the silicone basin 300 onto a serving plate, thereby avoiding possible damage to more fragile food products. Finally, the removable carrier vessel 400 adds structural stability for easier handling compared to a naked silicone basin 300. This will allow the user to easily handle and transport the cookware with just one rather than both hands.

In one embodiment, the silicone basin 300 has one or more tabs 500, 502 (FIGS. 5 and 6) formed seamlessly from the same silicone material that protrude away from the removable carrier vessel 400. These tabs 500, 502 serve several purposes. They facilitate the removal of the silicone basin 300 from the removable carrier vessel 400. The tabs 500, 502 can also be the means by which the basin 300 suspends from the periphery of the cavity of the removable carrier vessel 400 to form the spatial gap 600 (see FIG. 6). Further, even though the basin 300 is structurally sound to be handled by grasping onto the rim 306 or the side wall 304, these tabs 500, 502 can also serve as carrying handle for the basin 300. The shape, size, thickness, and the number of the tabs 500, 502 will depend on the size of the basin 300 and intended use of the cookware. In other words, the volume and weight of the food material that is likely to be contained in the basin 300 will determine how large or sturdy the tabs 500, 502 will have to be. For example, if Applicant's silicone cookware is designed to be used for making a single serving of custard tart, the tabs 500, 502 need not be very large. On the other hand, if Applicant's silicone cookware is designed to be used for baking a 12-inch round sheet cake, the tabs 500, 502 should be sized to withstand the weight of the cake batter.

With its numerous improvements, Applicant's cookware addresses the need for a silicone cookware that does not suffer from handling problems. It also addresses the need for a silicone cookware that promotes uniform heat distribution to food material contained therein and prevent unevenly cooked product. Applicant's silicone cookware can be used in a variety of environment, including conventional or radiation oven, refrigerator, or freezer.

The description of the present invention has been presented for purposes of illustration and description, and is not intended to be exhaustive or limited to the invention in the form disclosed. Many modifications and variations will be apparent to those skilled in the art. The embodiments were chosen and described in order to best explain the principles of the invention, the practical application, and to enable others of ordinary skill in the art to understand the invention for various embodiments with various modifications as are suited to particular use contemplated. It will be understood by one of ordinary skill in the art that numerous variations will be possible to the disclosed embodiments without going outside the scope of the invention as disclosed in the claims.

I claim:

1. A cookware comprising:
a) a basin formed from food-grade silicone having at least one cavity with an opening, wherein said basin further comprises a base and a side wall; and
b) a removable carrier vessel having at least one cavity for receiving said basin.

2. The cookware of claim 1, further comprising:
c) a removable cover formed from food-grade silicone having a geometry to enclose said opening of said cavity of said basin.

3. The cookware of claim 2, wherein said removable cover is planar.

4. The cookware of claim 2, wherein said removable cover comprises at least one cavity with an opening having a geometry equivalent to said opening of said cavity of said basin.

5. The cookware of claim 2, further comprising at least one aperture located on said removable cover.

6. The cookware of claim 1, further comprising a rim formed seamlessly along the periphery of said opening of said cavity of said basin, wherein said rim has a thickness greater than a thickness of said basin.

7. The cookware of claim 6, further comprising one or more grip portions formed seamlessly from food-grade silicone, wherein said one or more protrusion is located along said rim of said basin.

8. The cookware of claim 1, wherein said inner surface of said basin comprises one or more edges, wherein said edges of said inner surface of said basin are smoothly rounded.

9. The cookware of claim 1, wherein said base of said basin comprises at least one planar surface formed from food-grade silicone, wherein said planar surface of said base is parallel to said opening of said cavity of said basin.

10. The cookware of claim 9, wherein said thickness of said basin is greater along said planar surface than thickness along other surfaces of said basin.

11. The cookware of claim 1, wherein said removable carrier vessel is formed from thermally insulating material.

12. The cookware of claim 1, wherein said removable carrier vessel is formed from ceramic material.

13. The cookware of claim 1, further comprising a spatial gap between said outer surface of said basin and said inner surface of said removable carrier vessel.

14. The cookware of claim 6, further comprising a spatial gap between said outer surface of said basin and said inner surface of said removable carrier vessel, wherein said basin is suspended by said rim resting on the periphery of said cavity of said removable carrier vessel.

15. The cookware of claim 7, further comprising a spatial gap between said outer surface of said basin and said inner surface of said removable carrier vessel, wherein said basin is suspended by said protrusion resting on the periphery of said cavity of said removable carrier vessel.
